(19) United States
(12) Patent Application Publication
(10) Pub. No.: US 2006/0210080 A1
(43) Pub. Date: Sep. 21, 2006

(54) Key synchronization in a visual cryptographic system

(75) Inventors: Pim Theo Tuyls, Eindhoven (NL); Martin Erik Van Dijk, Cambridge, MA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,359

(22) PCT Filed: Nov. 17, 2003
(86) PCT No.: PCT/IB03/05236

§ 371 Date: Jun. 15, 2005

(51) Int. Cl. H04K 1/00

(52) U.S. Cl. 380/274

(57) ABSTRACT

A system for visual cryptography comprises a server (1) for encrypting a series of images using a set of keys, a terminal (2) for displaying the encrypted images, a transmission medium (4) for transmitting the encrypting images from the server to the terminal (2), and a decryption device (3) for decrypting the encrypted image displayed on the terminal. A key identification is produced by the server (1) and displayed by the terminal (2). The decryption device (3) senses the key identification and selects the corresponding key from its key set.

The present invention relates to key synchronization in cryptographic systems. More in particular, the present invention relates to a method of and a system for synchronizing a first key set in an encryption device and a second key set in a decryption device, the encryption device being capable of encrypting images and the decryption device being capable of decrypting images.

It is well known to use key sets in cryptographic systems, subsequent messages being encrypted using different keys of the key set. The use of different keys for different messages makes it much harder for an eavesdropper to decrypt any of the messages. In addition, knowledge of a single key will only allow a single message to be decrypted, all other messages remaining secret.

It is, of course, necessary to synchronize the key sets, that is, to ensure that both the encryption device and the decryption device use the same key of the key set to encrypt or decrypt the same message. If this synchronization is lost, it will not be possible to decrypt the messages correctly.

It is further known to encrypt an image in order to prevent the image being recognized or to prevent its contents being read by unauthorized persons. One technique of encrypting an image is disclosed in, for example, European Patent Application EP 0 260 815. This technique, also known as visual cryptography, employs two patterns, each of which cannot be recognized individually, which are overlaid to produce a recognizable image. To this end, the original image is transformed into two randomized parts or patterns, neither of which contains any perceptible image information. One of these patterns is printed on a transparency or displayed on an at least partially transparent display to act as a decryption key. When such patterns are overlaid, the patterns are combined and thus “decrypted” in the eye of the viewer.

Rather than working with transparencies which are cumbersome when larger amounts of individually encrypted images are to be viewed, it has been proposed to use a decoding (decryption) device. Two types of image decrypting devices can be distinguished: transparent and non-transparent devices.

Transparent decrypting devices essentially mimic the transparent sheets used in the Prior Art and display one pattern (“share”) of the encrypted image. As the decrypting device is at least partially transparent, the other pattern of the image can be seen through the device and the two image patterns are combined in the eye of the viewer as before. The advantage of using a transparent device instead of a transparent sheet is that the device is capable of displaying a plurality of image parts rather than a single image part. Thus subsequent images can use different keys. Transparent decrypting devices advantageously use LCD (Liquid Crystal Display) screens, two such screens being overlaid to “decrypt” the encrypted image so as to reconstruct the original image. A suitable example of a transparent device in which LCD screens are employed is described in European Patent Application 02075527.8[PHNL020121]. In the device of said European Patent Application, use is made of the polarization rotating effect of liquid crystal cells in a liquid crystal display. This allows a very convenient encrypting and decrypting of black-and-white images. European Patent Application 02078660.4[PHNL020804] describes a transparent decrypting device which also allows color images to be decrypted.

Non-transparent decrypting devices are capable of sensing the encrypted image, performing a decryption and displaying the decrypted image. The decryption is carried out in the device itself and the display shows the complete, decrypted image, while the encrypted image is masked by the device. An example of such a decoding device is described in European Patent Application 02079579.5[PHNL021058]. The decoding device may use a key to decrypt the image.

An image decoding device will generally require at least one key to decrypt an image. However, to encrypt and decrypt multiple images in a cryptographically secure manner it is necessary to employ a key set of which different keys are used to decrypt subsequent images. The use of a key set does, however, introduce the problem of key set synchronization. Even when a certain key sequence is predetermined, the encryption device and the decryption device may accidentally change keys at different moments, or one of the devices may not change keys at all, resulting in a loss of key synchronization. This, in turn, will result in the decryption device not being capable of decrypting the encrypted images.

It is therefore an object of the present invention to provide a method and system for establishing the synchronization of an encryption device and a decryption device in a simple yet effective manner.

It is another object of the present invention to provide a method and system for establishing the synchronization of an image encryption device and an image decryption device.

Accordingly, the present invention provides a method of synchronizing a first key set in an encryption device and a second key set in a decryption device, the method comprising the steps of:
the encryption device producing an encrypted image and an associated key identification using a key of the first key set,
the encryption device transmitting the encrypted image and its associated key identification to a display device,
the display device displaying the encrypted image and its associated key identification,
the decryption device detecting the key identification,
the decryption device decrypting the encrypted images using a key of the second key set corresponding with the detected key identification, and
the decryption device displaying the decrypted image.

That is, the encryption device uses a key of its key set to encrypt the image and produces a key identification corresponding with the key used for encrypting the image. Both the encrypted image and the key identification are transmitted to the display device which allows the decryption device to detect the key identification. The decryption device uses the key identification to identify a key of its key set and then decrypts the encrypted image using the thus identified key. It is preferred that a decryption device is used of the type having both sensing means for sensing an (encrypted) image and display means for displaying a (decrypted) image.

By transmitting a key identification with the encrypted image, it will be possible to always maintain key synchronization. Although it is possible to transmit a key identification with every encrypted image, it may not be necessary to do so. Instead, a key identification may only be transmitted periodically, for example after a certain number of encrypted images has been transmitted, or after a certain amount of time has elapsed. Alternatively, the key identification can only be transmitted upon request. It will be understood that the step of producing a key identification can be omitted when its transmission is not required.

It is possible for the key identification to be identical to the actual key. This is, however, cryptographically not secure as the key identification may be intercepted during transmission. For this reason, it is preferred that the key identification is a code associated with the key, for example a key number. It is further preferred that the key identification is a code derived from the key. This provides a degree of tamper protection.

In a preferred embodiment the key identification is a hash value. Hash values are values which can be derived from a source value such as a cryptographic key using a hash function, a type of function which is well known in the field of cryptography. Typically a hash function is a one-way function, that is, a function for which it is not feasible to determine the inverse function. As a result, the hash value of the key can be readily determined, but it is not feasible to derive the key from the hash value. In this way, interception of the key identification does not compromise the key itself. In addition, any (unauthorized) alteration of a key will result in a different hash value and will prevent the unauthorized decryption of the encrypted image.

In a particularly advantageous embodiment, the step of the decryption device detecting the key identification involves the sub-steps of:
the decryption device detecting the hash value and storing it as a detected hash value,
the decryption device calculating the hash values of the second key set and comparing each calculated hash value with the detected hash value until a match is found.

By matching a hash value of the decryption device's key set with the detected hash value the correct key can readily be found.

It is of course possible to pre-calculate and store the hash values of the second key set in the decryption device. This requires, however, a substantial amount of memory space. It has been found that hash values can be calculated quickly and therefore it is preferred not the store the hash values.

Although the key identification can be transmitted separately, it is preferred that the key identification is part of the encrypted image. This provides both a simple transmission of the key identification and an easy detection by the decryption device. The key identification can form a sub-image of the encrypted image. This sub-image can be a symbol, a code or the like. The sub-image can also be encrypted using an additional key which is preferably the same for a series of images.

In a preferred embodiment, the key identification is displayed on the display device as a bar code. A bar code can easily be recognized and read by the decryption device. Other types of codes, however, can also be used. In particular, a time multiplexed code may be used where parts of the code are sequentially displayed. These parts, in turn, may or may not be constituted by bar codes.

The images used for synchronization according to the present invention may be monochrome images or color images. Although various techniques may be used for rendering color images in visual cryptography and similar applications, the liquid crystal display techniques described in European Patent Application 02078660.4 [PHNL020804EPP] are particularly suitable.

The present invention further provides a system for synchronizing a first key set in an encryption device and a second key set in a decryption device, the system comprising:
an encryption device for producing an encrypted image and an associated key identification using a key of the first key set and transmitting the encrypted image and the associated key identification to a display device,
a display device for displaying the encrypted image and its associated key identification, and
a decryption device for detecting the key identification, decrypting the encrypted image using a key of the second key set corresponding with the key identification, and displaying the decrypted image.

With a system of this type, a synchronization of the keys sets can be readily achieved.

The present invention also provides a decryption device for use in a system as defined above, the device comprising sensor means for sensing an encrypted image including a key identification, key selection means for selecting a key on the basis of the sensed key identification, decryption means for decrypting a sensed encrypted image using the selected key, and display means for displaying a decrypted image.

Advantageously, the sensor means are part of an LED (Light Emitting Diode) circuit, preferably an OLED (Organic Light Emitting Diode) circuit.

The present invention will further be explained below with reference to exemplary embodiments illustrated in the accompanying drawings, in which:

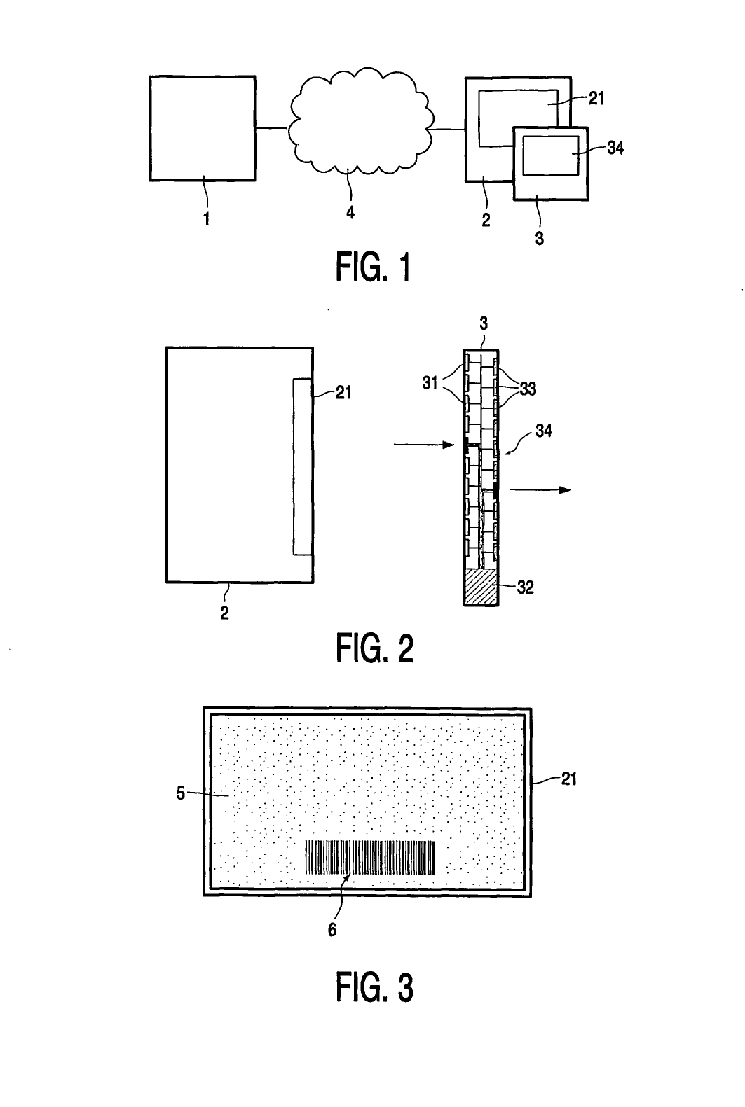

FIG. 1 schematically shows a cryptographic system according to the present invention.

FIG. 2 schematically shows, in cross-section, a decryptor for use in the system of FIG. 1.

FIG. 3 schematically shows an example of an image used in the system and method according to the present invention.

The system shown merely by way of non-limiting example in FIG. 1 comprises a server 1, a terminal 2, a decryptor (or decoder) 3 and a communication network 4. The server 1 produces and encrypts images which are transmitted via the communication network 4 to the terminal 2. The communication network 4 may be constituted by a dedicated network such as a LAN, a telephone network (POTS), the Internet, or a simple cable or wire. Both the server 1 and the terminal 2 may be dedicated devices or may be constituted by general purpose computers with, at least in the case of terminal 2, a display screen 21. The decryptor 3 is a cryptographic device which will be discussed in more detail below. The server 1 and the decryptor 3 are both provided with at least one key set consisting of a plurality of cryptographic keys. These keys are used in a suitable cryptographic process, such as DES. The particular cryptographic process used is not essential.

As shown in the exemplary embodiment of FIG. 2, the decryptor 3 is a decryption device which may include sensors 31 for sensing a displayed image, a processor 32 with an associated memory for performing cryptographic operations on the sensed image, and display elements 33 forming a display screen (34 in FIG. 1) for displaying the decrypted image. Electrical conductors or optical fibers connect the sensors 3 1, the processor 32 and the display elements 33. A set of cryptographic keys is stored in the processor memory. The decryptor 3 therefore is capable of sensing an encrypted image, decrypting the image, and displaying the resulting decrypted image. While the terminal 2 is a non-trusted device, the decryptor 3 is a trusted device which is preferably carried by its user and stored in a safe place when not in use. In this way the keys stored in the decryptor are not compromised.

The synchronization of key sets in the system of FIG. 1 is accomplished as follows. The server (encryption device) 1 encrypts an image using a key of its key set. This image is transmitted to the terminal (display device) 2 which displays the image. As the terminal 2 is not in possession of the keys, it is not able to decrypt the encrypted image. The displayed encrypted image contains no perceptible information and may have the appearance of a random image (“snow”).

The user positions her decryptor (decryption device) 3 in such a way that the decryptor can sense the image. The encrypted image schematically shown in FIG. 3 has two image portions, a first image portion 5 containing the encrypted image and a second image portion 6 containing the key identification. The decryptor 3 senses both images preferably simultaneously and is preferably arranged for determining which part of the image shown on display screen 21 is the second image portion 6. In a preferred embodiment a section of the screen 21 is assigned to the second (key identification) image portion 6 and therefore this image portion is recognized on the basis of its location.

In the example shown, the second image portion 6 contains a bar code. It is possible for the decryptor 3 to “scan” the display 21 and detect a bar code using well-known electronic image scanning techniques. In that case, it would not be necessary to assign a particular position to the second image portion. Instead of a bar code, other codes or (combination of) symbols could be used. It is further possible that such codes are recognized by the decryptor 3 using pattern recognition techniques. It is not necessary for the entire code to be displayed at a single moment and so-called time multiplexed codes may be used in which parts of the code are displayed sequentially, that is, at different moments in time. This may be accomplished by the temporary lighting up (or flashing) of certain display elements. The said parts of the code may themselves be represented by bar codes or any other suitable codes.

It is further possible to time multiplex the actual images and the key identification, that is, to show the first image 5 and the second image 6 not simultaneously but, for example, alternatingly.

In the embodiment shown the decryptor 3 recognizes and decodes the bar code contained in the second image portion 6 so as to obtain the key identification or a code representing the key identification. In the preferred embodiment, the (bar) code contained in the second image portion 6 is the hash value of the key.

The decryptor 3 then tries to match this detected hash value with one of the keys of its key set by computing the hash value of a key, comparing it with the detected hash value, and continuing with the next key if the detected hash value and the calculated hash value do not match. If no match is found, an error must have occurred. If a match is found, the decryptor then uses the key concerned to decrypt the first image portion 5 and to display the resulting decrypted image. In the position of the second image portion 6 a masking area (e.g. a blank area) may be inserted by the decryptor to mask the key identification.

To allow for small read or transmission errors, it could be decided that a “match” is found even if the detected hash value and the calculated value are not identical but are sufficiently similar. This can be determined by determining a suitable maximum acceptable “distance” between the detected and the calculated value, for example using the well-known Hamming distance measure. In the preferred embodiment, however, the distance equals zero, thus requiring the said values to be equal.

In order to provide protection against any transmission errors that may cause an incorrect key identification to be displayed, the actual key identification may optionally be extended with a CRC (Cyclical Redundancy Check) value or similar check value which allows error detection.

The key sets of the server and the decryptor are effectively identical, that is, each key of the server key set, when used in the server encryption process, produces an image which can be decrypted using an associated key in the decryptor key set, when used in the decryptor decryption process. In most embodiments the server key set and the decryptor key set will be identical, but this is not necessarily the case. The relationship between the keys may be illustrated as follows:
K [symbol] KID [symbol] K′
   where K is a key of the first key set, KID is the corresponding key identification, and K′ is the key of the second key set identified by the key identification. On the basis of the first key K a key identification KID is produced which is used by the decryptor to identify its corresponding key K′. In most cryptographic systems K and K′ will be identical.

In the above discussion it was assumed that the decryptor (decryption device) 3 displays the entire decrypted image. This is not necessarily the case and embodiments can be envisaged in which the decryptor 3 only displays part of the image to allow “visual cryptography” techniques as disclosed in e.g. European Patent Application EP 0 260 815 mentioned above. In such embodiments the decryptor 3 is at least partially transparent, one part or “share” of the image being displayed by the decryptor, the other part or “share” being displayed by the terminal display 21. A suitable example of a transparent device in which LCD screens are employed is described in European Patent Application 02075527.8[PHNL020121]. European Patent Application 02078660.4[PHNL020804] describes a transparent decrypting device which also allows color images to be decrypted. These transparent devices should, however, also be provided with sensors (31 in FIG. 2) or other suitable sensing means for sensing the displayed key identification.

The present invention is based upon the insight that information identifying a key can be displayed in an encrypted image, allowing this information to be detected by a decoding device. The present invention is additionally based upon the further insight that an untrusted device (i.e. the display device) can be used to provide information pertaining to keys, as the untrusted device has no knowledge of the keys themselves.

Although the present invention is in particular applicable in systems for cryptographically transferring images, such as “visual cryptography”, it can also be applied in other cryptographic systems where other data items than images are cryptographically protected. It can be envisaged, for instance, that the present invention be applied in computer systems where encrypted data (files) are transferred between computers, the computer screens being used for key synchronization.

It is noted that any terms used in this document should not be construed so as limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A method of synchronizing a first key set in an encryption device and a second key set in a decryption device, the method comprising the steps of:
the encryption device producing an encrypted image and an associated key identification using a key of the first key set,
the encryption device transmitting the encrypted image and its associated key identification to a display device,
the display device displaying the encrypted image and its associated key identification,
the decryption device detecting the key identification,
the decryption device decrypting the encrypted images using a key of the second key set corresponding with the detected key identification, and
the decryption device displaying the decrypted image.

2. The method according to claim 1, wherein the key identification is a code derived from the key.

3. The method according to claim 2, wherein the key identification is a hash value.

4. The method according to claim 3, wherein the step of the decryption device detecting the key identification involves the sub-steps of:
the decryption device detecting the hash value and storing it as a detected hash value,
the decryption device calculating the hash values of the second key set and comparing each calculated hash value with the detected hash value until a match is found.

5. The method according to claim 1, wherein the key identification is part of the encrypted image.

6. The method according to claim 5, wherein the key identification is displayed on the display device as a bar code and/or a time multiplexed code.

7. A system for synchronizing a first key set in an encryption device and a second key set in a decryption device, the system comprising:
an encryption device for producing an encrypted image and an associated key identification using a key of the first key set and transmitting the encrypted image and the associated key identification to a display device,
a display device for displaying the encrypted image and its associated key identification, and
a decryption device for detecting the key identification, decrypting the encrypted image using a key of the second key set corresponding with the key identification, and displaying the decrypted image.

8. The system according to claim 7, wherein the key identification is a code derived from the key.

9. The system according to claim 8, wherein the key identification is a hash value.

10. The system according to claim 9, wherein the decryption device detects the key identification by:
detecting the hash value and storing it as a detected hash value, and
calculating the hash values of the second key set and comparing each calculated hash value with the detected hash value until a match is found.

11. The system according to claim 7, wherein the key identification is part of the encrypted image.

12. The system according to claim 7, wherein the key identification is displayed on the display device as a bar code and/or a time multiplexed code.

13. A decryption device for use in a system according to any of claims 7-12, the device comprising sensor means for sensing an encrypted image and a key identification, key selection means for selecting a key on the basis of the sensed key identification, decryption means for decrypting a sensed encrypted image using the selected key, and display means for displaying a decrypted image.

14. The decryption device according to claim 13, wherein the sensor means are constituted by photo diodes.

15. The decryption device according to claim 14, wherein the sensor means are part of an LED circuit, preferably an OLED circuit.
